(19) United States
(12) Patent Application Publication
(10) Pub. No.: US 2005/0218281 A1
(43) Pub. Date: Oct. 6, 2005

(54) Tank support bracket

(76) Inventor: Richard F. Klein, Ontario, CA (US)

Correspondence Address: BRANDE AND MCCLEARY, 5976 FALLING TREE LANE, ALTA LOMA, CA, 91737, US

(21) Appl. No.: 10/817,673

(22) Filed: Apr. 2, 2004

(51) Int. Cl. F16B 1/00

(52) U.S. Cl. 248/228.3

(57) ABSTRACT

This invention describes a bolster bracket assembly for a tank assembly mounted on a truck that fastens the tank assembly to the truck. The mounted tank assembly will have at least two upper support brackets mounted on the front left and right sides of the tank assembly and at least two upper support brackets mounted on the rear left and right sides of the tank assembly. A first and second bottom support bracket are oriented with the upper support brackets and bolt assemblies connect the brackets to allow easy connection and removal of the tank assemblies on the truck bed.

### BACKGROUND OF THE INVENTION

1. Field of the Invention

Trucks that travel on roads require that the body portion be fully attached to the truck or trailer frame. Standard storage vans or tanks generally are built so the frame is smaller than the overall cargo compartment, with the result that the truck or trailer requires additional support under the floor of the van or tank in order to support the weight of the cargo. Generally the cargo van or tank is either bolted or welded to the truck or trailer frame. In other cases the cargo van or tank bed is isolated from the frame with supports that act as shock absorbers to cushion the cargo body.

2. Description of the Prior Art

Bolster brackets are known in the art under differing nomenclature.

U.S. Pat. No. 4,342,106 by Fischer discloses a “Shock-Absorbing Vehicle Frame/Chassis Mounting System. This system consists primarily of a Z shaped member that attaches to a cargo bed. A hole in the Z shaped member allows a bolt to pass through. A rubber bushing with an internal metal sleeve bushing cushions the Z shaped member. The bolt then passes through a frame rail and another rubber bushing under the frame rail. A nut is threadably engaged onto the nut and bears against a washer, lightly crushing both rubber bushings, thereby providing a cushioned support.

U.S. Pat. No. 4,720,075 by Peterson et al. Discloses a “Shock Isolating Mount”. This devices is a two piece device comprising some elastomeric components that is used to secure a body part of a vehicle to a support. It overcomes previous shortcomings by eliminating left hand tube threading for subassembly. Generally this mount is used in applications that are substantially different than the present invention.

### SUMMARY OF THE INVENTION

It is therefore the object of the present invention to provide for a simplified mounting system to attach tanks or cargo containers to existing truck chassis, without the need to drill holes into the frame rails or the tank structure.

It is a further object of the invention to provide a mounting system that will allow the owner of a truck with the present invention to easily change the mounted tanks or cargo containers since the positioning of the mounts is easily repeatable for interchangeability.

### BRIEF DESCRIPTION OF THE DRAWINGS

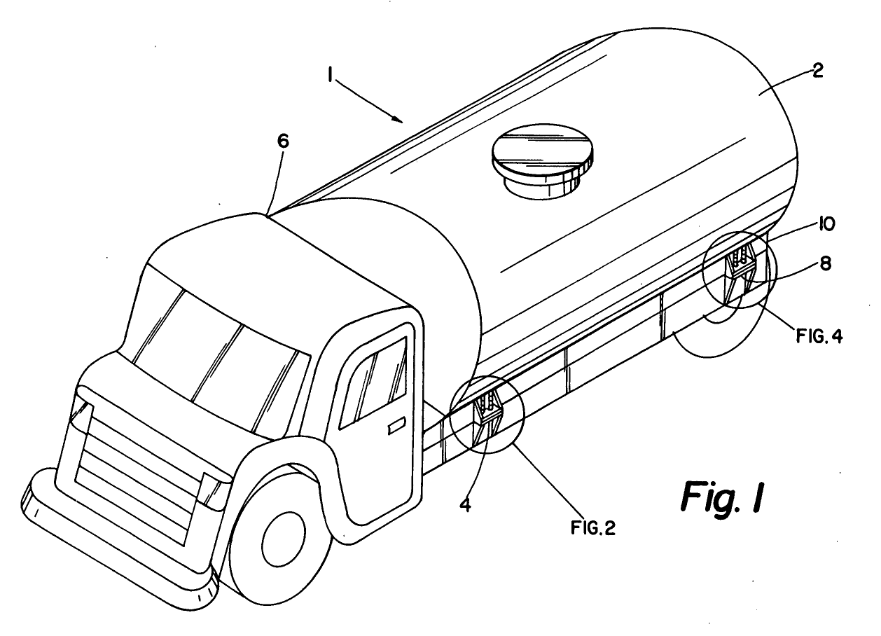

1. FIG. 1 shows an overall perspective of a tanker truck

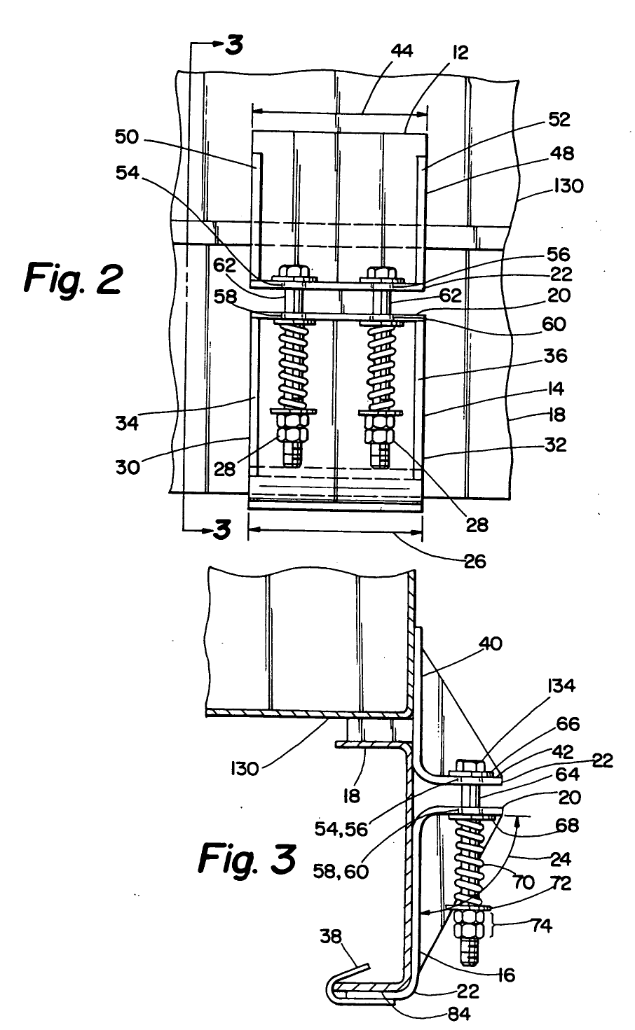

2. FIG. 2 shows a left view of a forward bracket assembly

3. FIG. 3 shows a cross sectional view of the forward bracket assembly

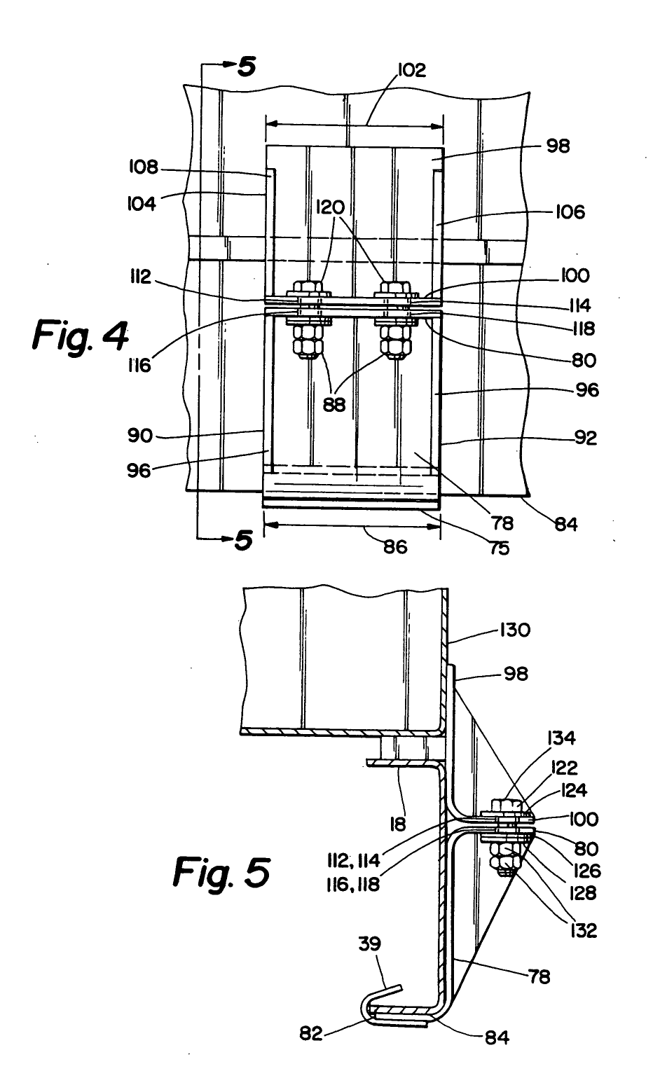

4. FIG. 4 shows a left view of a rear bracket assembly

5. FIG. 5 shows a cross sectional view of the rear bracket assembly

### DETAILED DESCRIPTION

In referring to figure one, a truck (1) is shown with a mounted tank or van assembly (2). A forward bracket assembly (4) is shown being biased towards the front (cab) (6) of the truck (1), while a rear bracket assembly (8) is shown biased towards the rear (10) of the truck (1), preferably behind the rear axles.

With respect to FIG. 2, the front bracket assembly (4) is shown having a first upper support bracket (12) and a first bottom support bracket (14). The first bottom support bracket (14) is shown here “Z” shaped, and is generally fabricated from flat metallic sheet stock of at least ¼ (0.25) inch thick. The first bottom support bracket (14) has a first flat web (16), where the first flat web (16) is generally parallel to a truck chassis frame rail (18), which allows the first bottom support bracket (14) to lie flat against the truck chassis frame rail (18). The first bottom support bracket (14) has a first upper flange or cap (20) and a first lower flange or cap (22). The first upper cap (20) of the first bottom support bracket (14) is bent at an angle away from the truck chassis frame rail (18). The optimum first flange angle (24) is ninety degrees (90°). The first lower cap (22) of the first bottom support bracket (14) is formed to lay against a bottom portion (84) of the truck chassis frame rail (18). The first bottom support bracket (14) is shown having a first width (26), where the first width (26) is wide enough to provide adequate spacing for a set of fasteners (28). The first bottom support bracket (14) has a first edge (30) and a second edge (32). A first gusset (34) is attached to the first edge (30) of the first bottom support bracket (14), where the first gusset (34) is attached to the first flat web (16) and the first upper cap (20) of the first bottom support bracket (14). A second gusset (36) is shown attached to the second edge (32) of the first bottom support bracket (14), where the second gusset (36) is attached to the first flat web (16) and the first upper cap (20) of the first bottom support bracket (14). The first and second gussets (34, 36) provide structural support for the first bottom support bracket (14). A first bottom clamp (38) is shown as generally having a “c”, or “v” shape, where the first bottom clamp (38) maintains a clamping pressure between the first bottom support bracket (14) and the bottom portion (84) of the truck chassis frame rail (18) assuring that the first bottom support bracket (14) has intimate contact with the truck chassis frame rail (18).

The first upper support bracket (12) has a second flat web (40). A second lower flange or cap (42) is formed at an angle away from the truck chassis frame rail (18) and is fabricated to be essentially parallel to the upper cap (20) of the first bottom support bracket (14). The second flat web (40) is shown laying against the truck chassis frame rail (18) acting as a sway brace for side to side motion of the tank or van assembly (2). The first upper support bracket (12) has a second width (44) where the second width (44) is essentially equal to the first width (26) of the first bottom support bracket (14). The first upper support bracket (12) has a third edge (46) and a fourth edge (48). A third gusset (50) is attached to the third edge (46) of the first upper support bracket (12), where the third gusset (46) is attached to the second flat web (40) and the second lower flange (42). A fourth gusset (52) is attached to the fourth edge (48) of the first upper support bracket (12), where the fourth gusset (52) is attached to the second flat web (40) and the second lower flange (42). The third and fourth gusset (46, 52) provide structural support for the first upper support bracket (12).

The first upper support bracket (12) is attached to the tank or van assembly (2) and is mounted directly above the first bottom support bracket (14). The first upper support bracket (12) is positioned to allow the second flat web (40) to bear against the truck chassis frame rail (18). The second lower flange (42) of the first upper support bracket (12) has at least 2 holes, a first hole (54), and a second hole (56) defined therein. The upper flange (20) of the first bottom support bracket (14) has a third hole (58) and a fourth hole (60) defined therein, where the first hole (54) and the third hole (58) are oriented in line, and the second hole (56) and the fourth hole (60) are oriented in line. A bolt assembly (62) is installed the first and third hole (54, 58), and the second and fourth hole (56, 60). The bolt assembly (62) comprises a bolt (64), a first washer (66) a second washer (68) a spring (70) a third washer (72) and a locking feature (74) comprising a double nut configuration. The first washer (66) is shown bearing against the second lower cap (42) of the upper bracket (12) and the bolt head (134), while the second washer (68) is shown bearing against the first upper cap (20). The spring (70) bears against the second washer (68) and is compressed by the third washer (72) and the locking feature (74) here shown as a double nut configuration, where the double nut configuration allows for easy adjustment and tightening of the forward bracket assembly (4). The bolt assembly (62) shown allows the tank or van assembly (2) to be secured to the chassis and allow for flexure of the chassis under load.

The rear bracket assembly (8) is shown having a similar configuration to the front bracket assembly (4) and has a second bottom support bracket (75) and second upper support bracket (76). The second bottom support bracket (75) is shown here as a “Z” shaped bracket having a third flat web (78), where the third flat web (78) is parallel to and bears against the truck chassis frame rail (18), which allows the second bottom support bracket (75) to lie flat against the truck chassis frame rail (18). The second bottom support bracket (75) has a second upper flange or cap (80) and a third lower flange or cap (82). The second upper cap (80) of the second bottom support bracket (75) is bent at an angle away from the truck chassis frame rail (18). The optimum first flange angle (24) is ninety degrees (90°). The third lower cap (82) of the second bottom support bracket (75) is formed to lay against a bottom portion (84) of the truck chassis frame rail (18). The second bottom support bracket (75) is shown having a first width (86), where the first width (86) is wide enough to provide adequate spacing for a set of fasteners (88). The second bottom support bracket (75) has a fifth edge (90) and a sixth edge (92). A fifth gusset (94) is attached to the fifth edge (90) of the second bottom support bracket (75), where the fifth gusset (94) is attached to the third flat web (78) and the second upper cap (80) of the second bottom support bracket (75). A sixth gusset (96) is shown attached to the sixth edge (92) of the second bottom support bracket (75), where the sixth gusset (96) is attached to the third flat web (78) and the second upper cap (80) of the second bottom support bracket (75). The fifth and sixth gusset (94, 96) provide structural support for the second bottom support bracket (75). A second bottom clamp (39) is shown as generally having a “c”, or “v” shape, where the second bottom clamp (39) maintains a clamping pressure between the second bottom support bracket (75) and the bottom portion (84) of the truck chassis frame rail (18) assuring that the second bottom support bracket (75) maintains intimate contact with the truck chassis frame rail (18).

The second upper support bracket (76) has a fourth flat web (98). A fourth lower flange or cap (100) is formed at an angle away from the truck chassis frame rail (18) and is fabricated to be essentially parallel to the second upper cap (80) of the second bottom support bracket (75). The fourth flat web (98) is shown laying against the truck chassis frame rail (18) acting as a sway brace for side to side motion of the tank or van assembly (2). The second upper support bracket (76) has a third width (102) where the third width (102) is essentially equal to the first width (86) of the second bottom support bracket (75). The second upper support bracket (76) has a seventh edge (104) and a eighth edge (106). A seventh gusset (108) is attached to the seventh edge (104) of the second upper support bracket (76), where the seventh gusset (108) is attached to the fourth flat web (98) and the fourth lower cap (100). An eighth gusset (110) is attached to the eighth edge (106) of the second upper support bracket (76) where the eighth gusset (110) is attached to the fourth flat web (98) and the fourth lower cap (100). The seventh and eighth gussets (108, 110) provide structural support for the second upper support bracket (76). An eighth gusset (110) is attached to the eighth edge (106) of the second upper support bracket (76), where the eighth gusset (110) is attached to the fourth flat web (98) and the fourth lower cap (100).

The second upper support bracket (76) is attached to the tank or van assembly (2) and is mounted directly above the second bottom support bracket (75). The second upper support bracket (76) is positioned to allow the fourth flat web (98) to bear against the truck chassis frame rail (18). The fourth lower flange (100) of the second upper support bracket (76) has at least 2 holes, a fifth hole (112), and a sixth hole (114) defined therein. The second upper flange (80) of the second bottom support bracket (75) has a seventh hole (116) and an eighth hole (118) defined therein, where the fifth hole (112) and the seventh hole (116) are oriented in line, and the sixth hole (114) and the eighth hole (118) are oriented in line. A second bolt assembly (120) is installed into the first and third hole (112, 116), and the second and fourth hole (112, 116). The second bolt assembly (120) comprises a bolt (122), a fifth washer (124) a sixth washer (126), a seventh washer (128) and a locking feature (132) comprising a double nut configuration. The fifth washer (124) is shown bearing against the fourth lower cap (100) of the second upper support bracket (76) and the bolt head (134), while the sixth washer (126) is shown bearing against the first upper cap (20). The seventh washer (128) bears against the sixth washer (126) and is compressed by the seventh washer (128) and the locking feature (132) here shown as a double nut configuration, where the double nut configuration allows for easy adjustment and tightening of the rear bracket assembly (8).

The first upper support bracket (12) is mounted to a frame rail (130) of the mounted tank or van assembly (2) biased towards the front of the mounted tank or van assembly (2). The mounted tank or van assembly (2) will have at least two (2) first upper support brackets (12) mounted, one on the left side of the mounted tank or van assembly (2), and one on the right side of the mounted tank or van assembly. The first bottom support bracket (14) is mounted to the truck chassis frame rail (18) and oriented in line with the first upper support bracket (12). Similarly the second upper support bracket (76) is mounted to the frame rail (130) of the mounted tank or van assembly (2) and biased towards the rear of the truck chassis frame rail (18). The mounted tank or van assembly (2) will have at least two (2) second upper support brackets (76) mounted, one on the left side of the mounted tank or van assembly (2) and one on the right side of the mounted tank or van assembly (2). The second bottom support bracket (75) is mounted to the truck chassis frame rail (18) and oriented in line with the second upper support bracket (76).

The mounted tank or van assembly (2) is lowered over the truck chassis frame rail (18) and the second flat web (40) and the fourth flat web (98). The mounted tank or van assembly (2) is aligned over the truck chassis frame rail (18). The first bolt assembly (62) is attached to the first upper support bracket (12) and first bottom support bracket (14). The second bolt assembly (120) is attached to the second upper support bracket (76) and the second bottom support bracket (75).

The best method of attaching the first upper support bracket (12) and the second upper support bracket (76) to the mounted tank or van assembly (2) is by welding or braising, while the best method of attaching of attaching the first bottom support bracket (14) and the second bottom support bracket (75) to the truck chassis frame rails (18) is by welding or braising. This method would offer the most flexibility in assembling components that are easily replaced, while bolting the brackets to their respective rails would offer the greatest first time assembly flexibility at the cost of future repairs.

If the manufacturer invested greater amount of money in assembly tooling, then it is possible to weld the first and second bottom support brackets (14, 75) to the truck chassis frame rails (18), and provide adequate assembly flexibility.

Although the foregoing includes a description of the best mode contemplated for carrying out the invention, various modifications are contemplated.

As various modifications could be made in the constructions herein described and illustrated without departing from the scope of the invention, it is intended that all matter contained in the foregoing description or shown in the accompanying drawings shall be interpreted as illustrative rather than limiting.

1. A trailer support bracket comprising:
a. a front bracket assembly, said front bracket assembly comprising a first upper support bracket and a first bottom support bracket, said first bottom support bracket being generally “Z” shaped, said first upper support bracket being generally “L” shaped;
b. said first lower support bracket having a first flat web, said first flat web bearing against a truck chassis, said first lower support bracket additionally having a first upper cap and a first lower cap, said first lower cap bearing against a lower portion of said truck chassis, said first upper cap being formed away from said truck chassis, a first bottom clamp, said first bottom clamp forcing intimate contact of said first lower support bracket and said truck chassis;
c. said first upper support bracket having a second flat web, said second flat web being attached to a tank or van assembly and protruding downwards to also bear against said truck chassis, a second lower cap, said second lower cap being essentially parallel to said first upper cap of said first lower support bracket, said first upper cap of said first lower support, and said second lower cap of said first upper support being positioned with a space defined therebetween;
d. said first upper cap and said second lower cap each having two holes defined therein, said holes in said first upper cap, and said holes in said second lower cap being defined in line, and allowing a bolt assembly to be inserted each therethrough;
e. a rear bracket assembly, said rear bracket assembly comprising a second upper support bracket and a second bottom support bracket, said second bottom support bracket being generally “Z” shaped, said second upper support bracket being generally “L” shaped;
f. said second lower support bracket having a third flat web, said third flat web bearing against said truck chassis, said second lower support bracket additionally having a second upper cap and a third lower cap, said third lower cap bearing against the lower portion of said truck chassis, said second upper cap being formed away from said truck chassis, a second bottom clamp, said second bottom clamp forcing intimate contact between said second lower support bracket and said truck chassis;
g. said second upper support bracket having a fourth flat web, said fourth flat web being attached to said tank or van assembly and protruding downwards to also bear against said truck chassis, a fourth lower cap, said fourth lower cap being essentially parallel to said second upper cap of said second lower support bracket;
h. said second upper cap and said fourth lower cap each having two holes defined therein, said holes in said first upper cap, and said holes in said fourth lower cap being defined in line, and allowing a bolt assembly to be inserted each therethrough;
i. said second upper support bracket and said second lower support bracket being positioned behind a truck's rear axles, said first upper support bracket and said first lower support bracket being located towards a cab portion of the truck; and
j. said front and said rear bracket assembly each being installed on a left and a right side of said truck chassis.

2. A trailer support bracket comprising:
a. a front bracket assembly, said front bracket assembly comprising a first upper support bracket and a first bottom support bracket, said first bottom support bracket being generally “Z” shaped, said first bottom support bracket having a first flat web, said first flat web being generally parallel to a truck chassis and bearing against said truck chassis, a first upper cap, said first upper cap being formed away from said truck chassis, a first lower cap, said first lower cap being formed to nest against a lower portion of said truck chassis, a first bottom clamp, said first bottom clamp forcing intimate contact of said first lower support bracket and said truck chassis;
b. a first gusset means said first gusset means providing structural support and stiffness to said first bottom support bracket thereby;
c. said first upper support bracket being generally “L” shaped, said first upper support bracket having a second flat web and a second lower flange or cap defined thereby, said second lower cap being essentially formed parallel to said first upper cap of said first bottom support bracket, said second flat web being attached to a tank or van assembly and extending downwards to bear against said truck chassis acting as a sway brace thereby;
d. a second gusset means, said second gusset means providing structural support and stiffness thereby, said first bottom support bracket and said first upper support bracket being positionally aligned over each other;
e. said first upper cap of said first bottom support having at least two holes defined therein, said second lower cap of said upper support bracket having at least two holes defined therein, each of said holes in said upper cap being positioned in line with each of said holes in said lower cap allowing a first bolt assembly to be installed in each pair of holes thereby;
f. a rear bracket assembly, said rear bracket assembly comprising second bottom support bracket and a second upper support bracket, said second bottom support bracket being generally “Z” shaped, said second bottom support bracket having a third flat web, said third flat web being generally parallel to said truck chassis and bearing against said truck chassis, a second upper cap, said second upper cap being formed away from said truck chassis, a third lower cap, said third lower cap being formed to nest against said lower portion of said truck chassis, a second bottom clamp, said second bottom clamp forcing intimate contact of said first lower support bracket and said truck chassis;
g. a third gusset means, said third gusset means providing structural support and stiffness to said second bottom support bracket thereby;
h. said second upper support bracket being generally “L” shaped, said second upper support bracket having a fourth flat web and a fourth lower flange or cap defined thereby, said fourth lower cap being essentially formed parallel to said second upper cap of said second bottom support bracket, said fourth flat web being attached to said tank or van assembly and extending downwards to bear against said truck chassis acting as a sway brace thereby;
i. a fourth gusset means, said fourth gusset means providing structural support and stiffness to said second upper support bracket thereby, said second bottom support bracket and said second upper support bracket being positionally aligned over each other;
j. said second upper cap of said first bottom support having at least two holes defined therein, said fourth lower cap of said upper support bracket having at least two holes defined therein, each of said holes in said second upper cap being positioned in line with each of said holes in said fourth lower cap allowing a second bolt assembly to be installed in each pair of holes thereby; and
k. said front and said rear bracket assembly each being installed on a left and a right side of said truck chassis.

3. The trailer support bracket of claim 2 wherein;
a. said first gusset means comprises a first gusset and a second gusset, said first gusset attaching to a first edge of said first bottom support bracket, said second gusset attaching to a second edge of said first bottom support bracket, said first and said second gusset each attaching said first upper cap and said first flat web providing structural support and stiffness thereby;
b. said second gusset means comprises a third gusset and a fourth gusset, said third gusset attaching to a third edge of said first upper support bracket, said fourth gusset attaching to a fourth edge of said first upper support bracket, said third and said fourth gusset each attaching to said second flat web and said second lower flange of said first upper support bracket providing structural support and stiffness thereby;
c. said third gusset means comprises a fifth gusset and a sixth gusset, said fifth gusset attaching to a fifth edge, said sixth gussets attaching to a sixth edge, said fifth and said sixth gusset each attaching to said second upper cap and said third flat web providing structural support and stiffness thereby; and
d. said fourth gusset means comprises a seventh gusset and an eighth gusset, said seventh gusset attaching to a seventh edge, said eighth gusset attaching to an eighth edge, said seventh and eighth gusset each attaching to said fourth flat web and said fourth lower flange of said second upper support bracket providing structural support and stiffness thereby.

4. The trailer support bracket of claim 2 wherein said first bolt assembly comprises a bolt, a first washer, a second washer, a biasing means, a third washer, and a locking feature, said first washer bears against said second lower cap of said upper bracket and a bolt head said second washer bears against said first upper cap of said first bottom support bracket, said biasing means bears against said second washer and is compressed by said third washer and the said locking feature, said locking feature comprising a double nut configuration common in the construction industry, said double nut configuration allowing for easy adjustment and tightening of said first bolt assembly, said first bolt assembly allowing for flexure of said truck chassis under load.

5. The trailer support bracket of claim 2 wherein said second bolt assembly comprises a second bolt, a fifth washer, a sixth washer, a seventh washer, and a locking feature, said fifth washer bears against said fourth lower cap of said second upper support bracket and a bolt head, said sixth washer bears against said first upper cap of said first bottom support bracket, said seventh washer bears against said sixth washer and is compressed by said seventh washer and said locking feature, said locking feature comprising a double nut configuration common in the construction industry allowing for easy adjustment and tightening of said rear bracket assembly.

6. The trailer support bracket of claim 2 wherein said first bottom support bracket and said second bottom support bracket are bolted to said truck chassis frame rails.

7. The trailer support bracket of claim 2 wherein said first upper support bracket and said second upper support bracket are welded to said tank or van assembly.

8. The trailer support bracket of claim 2 wherein said first bottom support bracket and said second bottom support bracket are welded to said truck chassis frame rails.
